(19) United States
(12) Patent Application Publication
(10) Pub. No.: US 2010/0082276 A1
(43) Pub. Date: Apr. 1, 2010

(54) PROCESS FOR MONITORING A DRIVE TRAIN COMPONENT OF A WIND POWER PLANT

(75) Inventor: Edwin BECKER, Reken (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: PRUEFTECHNIK DIETER BUSCH AG, Ismaning (DE)

(21) Appl. No.: 12/569,154

(22) Filed: Sep. 29, 2009

(30) Foreign Application Priority Data
Sep. 29, 2008 (DE) 10 2008 049 530.1

(51) Int. Cl. G01M 13/02; F03D 7/02; G01H 1/00

(52) U.S. Cl. 702/56; 416/1; 73/570

(57) ABSTRACT

A process for monitoring a drive train component (22) of a wind power plant (10) with a rotor (12), the rotor rpm being detected, the wind power plant being controlled such that the rotor rpm rises during an acceleration phase, during the acceleration phase vibration signals being detected by at least one vibration sensor (30) attached to the drive train component in order to detect vibration spectra at different rotor rpm, and the vibration spectra detected at different rotor rpm being displayed as a superposition spectrum in order to evaluate the state of the drive train component.

### BACKGROUND OF THE INVENTION

1. Field of Invention

This invention relates to a process for monitoring a drive train component of a wind power plant.

2. Description of Related Art

In general, it is a known procedure in mechanical engineering to record so-called coasting curves for system diagnosis, a vibration sensor being attached at a suitable location on the system and the machine being accelerated until the setpoint rpm is exceeded. From this rpm, which is somewhat above the setpoint rpm, the rpm is then reduced to the setpoint, during this so-called coasting phase during which the rpm is reduced, a vibration spectrum is recorded. It is likewise possible to allow the machine to run from rated operation to stoppage for the coasting phase.

In wind power plants, it has now been shown that it is not especially helpful for diagnosis to record these coasting curves. First of all, it is not easily possible to set an rpm above the rated rpm at all, since the maximum rpm is essentially dictated by the wind. Furthermore, the coasting phase for wind power plants is typically rather short, i.e., the plant comes to rest relatively quickly, while the processes in the drive train of wind power plants generally require long measurement times. For these reasons, in wind power plants in the past, only measurements in the operating state were possible, i.e., at rated rpm of the rotor. One example of this practice can be found in German Patent Application DE 10 2005 017 054 A1 and corresponding U.S. Patent Application Publication 2008/0206052A1 where solid-borne noise measurements are taken on the rotor blades of a wind power plant in operation, i.e., at uniform rpm, in order to monitor the state of the rotor blades by means of spectral analysis. In measurements in the operating state, it is especially problematic that measured values must often be rejected since the wind conditions change during the required long measurement time, and thus, sufficiently constant conditions for an authoritative measurement cannot be assumed.

German Patent Application DE 198 41 947 A1 generally describes a process for measurement of solid-borne noise for technical diagnostics, vibration resonances being detected by traversing defined rpm ranges, especially in start-up processes. Signal evaluation in done in the time domain.

German Patent Application DE 24 56 593 A1 also mentions that vibration resonances in accelerating a rotating component to full rpm can be determined, there being no special use of this process. For determining the vibration resonances, the total amplitude, i.e., the amplitude integrated over all frequencies, is evaluated.

### SUMMARY OF THE INVENTION

A primary object of this invention is to devise a process for monitoring a drive train component of a wind power plant so that an authoritative evaluation will be easily enabled. This object is achieved in accordance with the invention by a process for a drive train component of a wind power plant with a rotor, in which the rotor rpm being detected, the wind power plant is controlled such that the rotor speed rises during an acceleration phase, during the acceleration phase the vibration signals are detected by means of at least one vibration sensor attached to the drive train component in order to detect vibration spectra at different rotor rpm, and vibration spectra detected at different rotor rpm are displayed as a superposition spectrum in order to evaluate the state of the drive train component.

In the design in accordance with the invention, it is advantageous that, because vibration spectra at different rotor rpm are detected by means of vibration signals which have been acquired during the acceleration phase and are displayed as a superposition spectrum, compared to conventional vibration measurements which take place solely at the rated rpm of the rotor of the wind power plant, much more authoritative diagnostics are enabled which still, compared to display by means of Campbell diagrams, Bode diagrams, waterfall spectra or the like, relatively, is not data-intensive.

Display of the vibration data as a superposition spectrum means that, in the superposition spectrum, the amplitude value for each frequency is formed by a certain mathematical operation from the amplitude values of the individual spectra for this frequency. Therefore, if the recorded spectra are the superposition spectrum, for example, at 20 different rpm, the amplitude value at, for example, 100 Hz in the superposition spectrum arises as a certain function of 20 amplitude values of the individual spectra at 100 Hz.

This function can be, for example, formation of a sum so that the superposition spectrum then would result as the sum of individual spectra. While evaluation of these sum spectra can be feasible in many cases, the superposition spectrum is formed, however, preferably by a “projection” of the individual spectra, i.e., the amplitude value in the superposition spectrum for each frequency is the amplitude value which is the largest at the time and which is shown by one of the individual spectra at this frequency. In other words, the mathematical function then involves the formation of the maximum for each frequency.

Thus, a superposition spectrum formed from n individual spectra contains only roughly 1/n of the amount of data of the individual spectra. It has now been shown that, in acceleration measurements on drive train components of wind power plants, in spite of this considerable, reduction in the number of data, relevant diagnosis conclusions are possible.

If several vibration sensors are used, a superposition spectrum can be formed separately, either from the individual spectra for each sensor which have been obtained from the measured values of one sensor, or the individual spectra obtained from the measured values of different sensors can also be considered in the superposition spectrum. In the latter case, then, in the superposition spectrum for a certain speed, several individual spectra, specifically originating from different sensors, can equally be considered.

The invention is explained in detail below by way of example with reference to the accompanying drawings.

### BRIEF DESCRIPTION OF THE DRAWINGS

The sole FIGURE is a schematic view of a wind power plant with a device for executing the monitoring process in accordance with the invention.

### DETAILED DESCRIPTION OF THE INVENTION

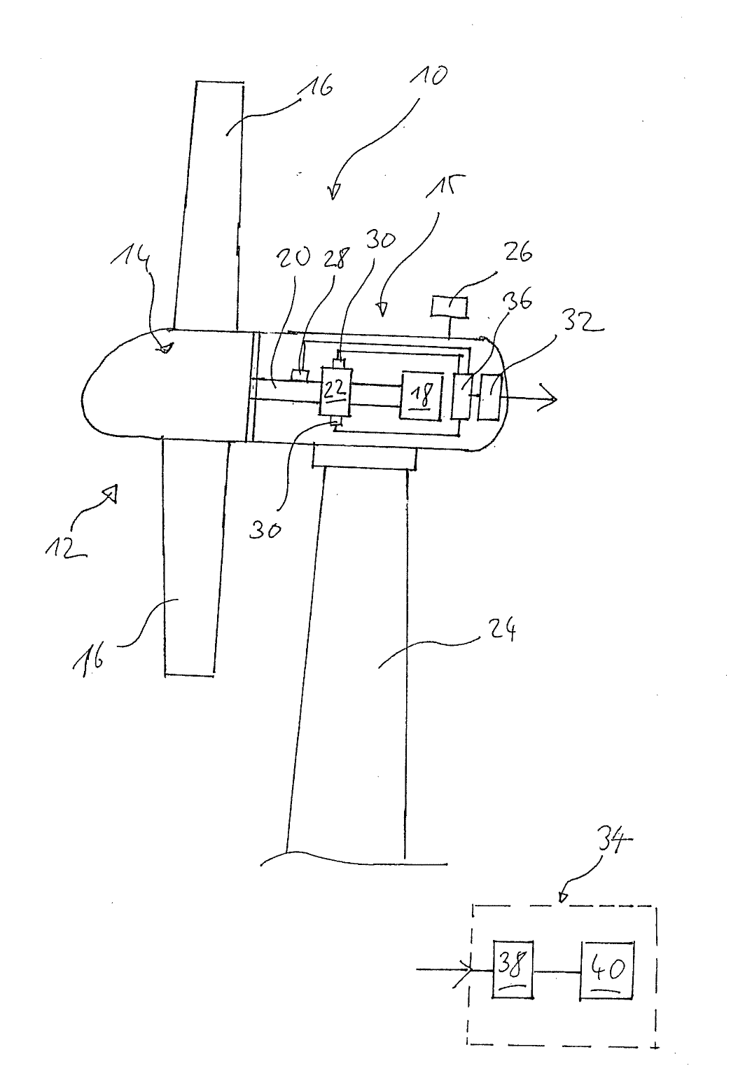

The sole figure shows an example of a wind power plant 10. Here, there is a rotor 12 with a hub 14 for three rotor blades 16 (of which only 2 are shown in FIG. 1). The rotor 12 is supported in a horizontal alignment in a gondola 15 which houses a generator 18 which is driven by the rotor shaft 20 by way of a transmission 22. The gondola 15 is pivoted around a vertical axis on a tower 24, and furthermore, has a sensor 26 for the wind speed and the wind direction. Moreover, there is a sensor 28 for detecting the rpm of the rotor 12. The rotor blades 16 are each adjustable by means of blade setting mechanism (not shown) around their lengthwise axis with respect to the hub 14 in order to set the pitch of the rotor blades 16 in the conventional manner.

Several vibration sensors 30 are attached to the transmission 22. These vibration sensors 30 can be attached, for example, axially or radially to the planetary gearing, the main bearing or to the bearing of the output shaft to the generator 18. The signals of the rpm sensor 28 and the signals of the vibration sensors 30 are routed to a data transfer means 32 which is designed to transfer data to a diagnosis site 34 which is located away from the wind power plant 10, data transfer preferably taking place over the Internet. Data transfer can be actively requested by the diagnosis site 34 or it takes place automatically at certain intervals by E-mail. Advantageously, a data processing unit 32 is connected upstream of the data transfer means 32 and undertakes a certain preprocessing of the collected data.

The diagnosis site 34 comprises a data processing unit 38 for conditioning the received data and a display means 40 for display of the conditioned data.

However, in other embodiments of the invention, on-line data transmission can be omitted so that evaluation of vibration measurements then takes place exclusively on site.

During an acceleration phase, during which the wind power plant 10 is controlled such that the rpm of the rotor 12 increases, vibration signals are detected by means of the vibration sensors 30 in order to detect vibration spectra at different rotor rpm, these vibration spectra detected at different rotor rpm being displayed as a superposition spectrum, for example, as a sum spectrum, or generally, which is more heavily preferred, as a projection with respect to the rpm axis (for each frequency, the amplitude value which is the highest at the time is taken from all individual spectra) in order to evaluate the state of the transmission 22 for diagnosis purposes. Conventionally, the acceleration of the rotor 12 takes place by the rotor 12 being turned more into the wind by turning it around the vertical axis and/or by the pitch angle of the rotor blades 16 being changed accordingly.

Since, in normal operation, more often acceleration of the rotor 12 takes place anyway, generally separate acceleration of the rotor 12 for diagnosis purposes is not necessary; rather, the vibration data which arise during the acceleration of the rotor 12 which is necessary in normal operation can be used. Thus, for example, all vibration data acquired in normal operation of the wind power plant 10 can be transmitted (e.g., via wireless internet or cellular transmitter) to a remote diagnosis site 34 where, then, for evaluation of the state of the transmission 22, only those vibration data which have been acquired in the acceleration phase are used for the superposition spectra.

Advantageously, for each of the vibration sensors 30, a separate superposition spectrum is prepared for diagnosis. Preferably, then, the superposition spectra which result from one of the vibration sensors 30 are displayed jointly for evaluation of the state of the transmission 22.

It has been found that, in the vibration measurement on drive train components of wind power plants during the acceleration phases, features can be recognized in the display as a superposition spectrum which are important for state monitoring. These features are, for example, resonant frequencies of the components of the drive train and tooth engagement frequencies of the transmission, especially the tooth engagement frequencies of the slow and fast spur gear stage. The spectra can be evaluated, for example, in the range from 0 to 2000 Hz, but also in addition in the range from 0 to 100 Hz, since it is also important to closely examine the range of very low frequencies, for example, in the region of a few Hz, for which long measurement times are necessary. It is in the low frequency region that characteristic resonant frequencies are recognized for the respective transmission. In the high frequency region, conversely, structural sound becomes apparent, for example, the tooth frequencies.

In this way, not only can wear phenomena for transmissions which have been in operation for a longer time be recognized, but also construction faults in new transmissions. There can be such a construction fault when resonant frequencies of the transmission, of the transmission housing, or the entire structure of the drive train are excited by the choice of a certain number of teeth on a gear.

Preferably, the signals of the sensors 30 during the acceleration phase are permanently detected, i.e., stored, in order to detect vibration data from a rpm range which is as wide as possible, the acceleration phase extending from the start of rotation of the rotor 12 from stoppage to reaching the rated rotor rpm for the prevailing wind strength.

Advantageously, the superposition spectra are plotted logarithmically for diagnosis.

In addition to evaluation of the superposition spectra, at least occasionally, analysis of the individual spectra can also take place in a three-dimensional display (with the rotor rpm at which the respective individual spectrum was recorded as the third dimension) in order to check or monitor the significance of evaluation of the superposition spectra.

In addition to the described analysis in the frequency domain, evaluation of the signals of the vibration sensors 30 can also take place in the time domain, here, the signals detected during the acceleration phase also being used. Advantageously, the sensor signals are filtered with respect to the rotor rpm (first order) by means of a suitable bandpass filter before evaluation, a multiple of the rotor rpm (higher order) or a characteristic frequency of the drive train component to be measured (for the transmission, for example, the tooth frequency of the slow spur gear stage or the tooth frequency of the fast spur gear stage). Preferably, the signals evaluated in the time domain are the detected vibration velocity.

While the invention has been illustrated so far using diagnosis of the transmission, it goes without saying that the invention is also suitable for monitoring of other drive train components.

Preferably, the detected vibration data are transmitted in preprocessed form to the diagnosis site 34, and for example, in this case, the transformation into the frequency domain, if necessary, the formation of the superposition spectra and filtering of the time signals with the rpm, etc., can be undertaken by the data processing unit 36 in the gondola 15. The data processing unit 36 can be made such that it undertakes transmission of the vibration data to the diagnosis site 34 only when changes in the superposition spectra which haven been detected and evaluated by the data processing unit 36 arise over time.

What is claimed is:

1. Process for monitoring a drive train component of a wind power plant with a rotor, comprising the steps of:
detecting the rotor rpm,
controlling the wind power plant so as to produce a rising rotor speed during an acceleration phase,
during the acceleration phase, detecting vibration signals by means of at least one vibration sensor attached to a drive train component for detecting vibration spectra at different rotor rpm, and
displaying vibration spectra detected at different rotor rpm as a superposition spectrum for evaluating the state of the drive train component.

2. Process in accordance with claim 1, comprising the further step of transmitting the detected vibration data online to a diagnosis site remote from the wind power plant to enable remote evaluation the state of the drive train component.

3. Process in accordance with claim 2, wherein preprocessing of the detected vibration data, including transformation into a frequency domain, is performed prior to the online transmission step.

4. Process in accordance with claim 2, wherein vibration data detected in normal operation of the wind power plant are also transmitted to the diagnosis site by means of the superposition spectrum with only those vibration data which were acquired in an acceleration phase being used for evaluation of the state of the drive train component.

5. Process in accordance with claim 1, wherein said at least one vibration sensor comprises a plurality of vibration sensors attached to different measurement points on the drive train component.

6. Process in accordance with claim 5, wherein a separate superposition spectrum is prepared for each vibration sensor.

7. Process in accordance with claim 6, wherein the superposition spectra from the plurality of vibration sensors are displayed jointly for evaluation of the state of the drive train component.

8. Process in accordance with claim 5, wherein a common superposition spectrum is prepared with data from several of the vibration sensors.

9. Process in accordance with claim 1, wherein evaluation is performed using, for each frequency, the amplitude value from all individual spectra which is the highest at the time.

10. Process in accordance with claim 1, wherein the vibration spectra are recorded in a range from 0 to 2000 Hz for evaluation in the form of superposition spectra.

11. Process in accordance with claim 1, wherein the vibration spectra are recorded in a range from 0 to 100 Hz for evaluation in the form of superposition spectra.

12. Process in accordance with claim 1, wherein sensor signals detected during the acceleration phase in the time domain are also used for evaluation of the state of the drive train component.

13. Process in accordance with claim 12, wherein the sensor signals detected in the time domain are filtered before evaluation by means of a bandpass filter with respect to one of rotor rpm, a multiple of rotor rpm and a characteristic frequency of the drive train component.

14. Process in accordance with claim 12, wherein the sensor signals detected in the time domain are vibration velocity signals.

15. Process in accordance with claim 1, wherein vibration spectra are detected in the acceleration phase for rotor rpm from the start of rotation of the rotor to reaching of the rated rotor rpm.

16. Process in accordance with claim 1, wherein the sensor signals are permanently detected during the acceleration phase.

17. Process in accordance with claim 1, wherein the drive train component is a transmission by which a generator is driven by a rotor shaft.
